(19) United States
(12) Patent Application Publication
(10) Pub. No.: US 2011/0074822 A1
(43) Pub. Date: Mar. 31, 2011

(54) Viewing Direction Determination Method, Viewing Direction Determination Apparatus, Image Processing Method, Image Processing Apparatus, Display Device and Electronic Device

(76) Inventor: Yao-Tsung Chang, Taipei Hsien (TW)

(21) Appl. No.: 12/788,274

(22) Filed: May 26, 2010

(30) Foreign Application Priority Data
Sep. 28, 2009 (TW) 098132786

(51) Int. Cl. G06F 3/01; G06K 9/00; G09G 5/00

(52) U.S. Cl. 345/649; 382/118; 345/660; 345/156

(57) ABSTRACT

A viewing direction determination method for determining a viewing direction of a viewer when observing an object includes receiving a facial image of the viewer when observing the object, identifying a plurality of facial features in the facial image to generate an identification result, and determining a facial direction of the viewer when observing the object according to the identification result to determine the viewing direction.

### BACKGROUND OF THE INVENTION

1. Field of the Invention

The present invention is related to viewing direction determination method, viewing direction determination apparatus, image processing method, image processing apparatus, display device and electronic device, and more particularly, to viewing direction determination method, viewing direction determination apparatus, image processing method, image processing apparatus, display device and electronic device capable of enhancing precision of determining viewing direction and increasing efficiency of related applications.

2. Description of the Prior Art

With advances of technology and industry, portable electronic devices, such as notebook computers, personal digital assistants (PDAs), mobile phones, MP3 walkmans, etc., are frequently used in daily life. In general, the portable electronic devices are equipped with display screens for showing images, and some advanced appliances like PDA, smart phone, etc. are equipped with touch screens for simultaneously reaching display and control functions.

On the other hand, to enhance utilization convenience, a portable electronic device no longer shows images in a single direction but alters to vertical or horizontal direction. Meanwhile, the prior art has disclosed a scheme for automatically switching a display direction of a portable electronic device, which uses a gravity sensor (G-sensor) to sense an angle of the portable electronic device when a user holds the portable electronic device, and accordingly, switches the display direction. For example, please refer to FIG. 1A and FIG. 1B, which are schematic diagrams of a prior art smart phone 10 when switching the display direction. In FIG. 1A and FIG. 1B, an arrow G represents a direction of gravity. When the user switches a holding method from FIG. 1A to FIG. 1B, the smart phone 10 can determine a viewing direction of the user based upon gravity variances, so as to change the displayed picture from FIG. 1A to FIG. 1B.

Via the display direction switching scheme illustrated in FIG. 1A and FIG. 1B, the prior art can enhance convenience and fun of operating the smart phone 10. However, such a switching scheme has an obvious disadvantage due to gravity detection. For example, when the smart phone 10 is horizontally placed on a flat platform like a desktop, no gravity variance can be sensed, such that the above scheme cannot accurately change the display direction.

Therefore, the viewing direction determination method of the prior art has to be improved.

### SUMMARY OF THE INVENTION

It is therefore a primary objective of the claimed invention to provide a viewing direction determination method, viewing direction determination apparatus, image processing method, image processing apparatus, display device and electronic device.

The present invention discloses a viewing direction determination method for determining a viewing direction of a viewer when observing an object. The viewing direction determination method comprises acquiring a facial image of the viewer when observing the object, identifying a plurality of facial features in the facial image to generate an identification result, and determining a facial direction of the viewer when observing the object according to the identification result to determine the viewing direction.

The present invention further discloses a viewing direction determination apparatus for determining a viewing direction of a viewer when observing an object. The viewing direction determination apparatus comprises a facial image acquisition module for acquiring a facial image of the viewer when observing the object, a facial feature identification module for identifying a plurality of facial features in the facial image to generate an identification result, and a determination module for determining a facial direction of the viewer when observing the object according to the identification result to determine the viewing direction.

The present invention further discloses an image processing method for a display device comprising a screen. The image processing method comprises receiving an image data comprising a plurality of pixel data corresponding to a plurality of display units of the screen, determining a viewing direction of a user when observing the screen, adjusting the display units corresponding to the plurality of pixel data according to the viewing direction, and the plurality of display units displaying the adjusted pixel data to display a frame corresponding to the image data.

The present invention further discloses an image processing apparatus for a display device comprising a screen. The image processing apparatus comprises a reception module for receiving an image data comprising a plurality of pixel data corresponding to a plurality of display units of the screen, a viewing direction determination apparatus for determining a viewing direction of a user against the screen, an adjustment module for adjusting the display units corresponding to the plurality of pixel data according to the viewing direction, and a display module for driving the plurality of display units to display the adjusted pixel data to display a frame corresponding to the image data.

The present invention further discloses a display device capable of automatically alternating viewing directions. The display device comprises a screen comprising a plurality of display units, an image data generator for generating an image date comprising a plurality of pixel data corresponding to the plurality of display units, and an image processing apparatus for processing the image data and displaying the processed image data through the screen comprising a reception module for receiving the image data, a viewing direction determination apparatus for determining a viewing direction of a user against the screen, an adjustment module for adjusting the display units corresponding to the plurality of pixel data according to the viewing direction, and a display module for driving the plurality of display units to display the adjusted pixel data to display a frame corresponding to the image data.

The present invention further discloses an electronic device capable of displaying comprising a screen comprising a plurality of display units, and an image processing apparatus comprising a reception module for receiving an image data comprising a plurality of pixel data corresponding to the plurality of display units of the screen, a viewing direction determination apparatus for determining a viewing direction of a user against the screen, an adjustment module for adjusting display units to be corresponding to the plurality of pixel data according to the viewing direction of the user against the screen, and a display module for driving the plurality of display units to display the adjusted pixel data to display a frame corresponding to the image data.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1A and FIG. 1B are schematic diagrams of a prior art smart phone when switching a display direction.

FIG. 2 is a schematic diagram of a face of a viewer.

FIG. 3 is a schematic diagram of a viewing direction determination process according to an embodiment of the present invention.

FIG. 4 is a schematic diagram of a viewing direction determination apparatus according to an embodiment of the present invention.

FIG. 5 is a schematic diagram of a display device according to an embodiment of the present invention.

FIG. 6A is a schematic diagram of an image obtained when facing a user from a side of a screen shown in FIG. 5.

FIG. 6B is a schematic diagram of an angle between a horizontal facial direction of the user and a horizontal direction of the screen shown in FIG. 6A.

FIG. 7 is a schematic diagram of a coordinate transformation according to an embodiment of the present invention.

FIG. 8 is a schematic diagram of an image processing process according to an embodiment of the present invention.

FIG. 9A to FIG. 9G are schematic diagrams of a smart portable device according to an embodiment of the present invention.

### DETAILED DESCRIPTION

To describe the spirit of the present invention, first explain how a human brain recognizes images received by eyes. Note that, “images” herein refer to all the visual activities induced by light reflection, and are not limited to pictures or frames. When incident light enters an eyeball from a pupil and focuses at sensing cells distributed on a retina with middle refractions induced by crystalline lens, visual nerves deliver messages generated by the sensing cells to the brain. Once entering the brain, the messages split into pieces transmitted to different cortex areas of the brain. Some cortex areas like temporal lobe and occipital lobe can immediately generate visions, and other cortex areas like parietal lobe can piecewise record images. As long as images of the same type are recorded for multiple times, the cortex gathers enough information and generates so called “memories” or “impressions”, i.e. the basis for recognizing future images. Meanwhile, within all “impressions” corresponding to the same image, only the “impression” appearing repeatedly would be deeply memorized, and that is why people can not only recognize images but determine whether or not images known already are correct or normal. For example, a general (deeply-memorized) impression of a tree is “roots are below leaves” for most people, and people can immediately recognize that a picture is reversely placed if roots of a tree are above leaves in the picture.

Since impressions are memorized with directions in human brains, artificial products should be presented in accordance with impressions of most people, i.e. consist with a “viewing direction” of a viewer. “Viewing direction” is an abstract concept and represents a direction from human eyes to a target object in ordinary cases. In practice, the viewing direction is hard to be modeled since senses of the viewing direction are not caused by eye organizations but by impressions stored in human brains, which highly depend on background, education, etc. of the viewer. For example, if someone has been taught that “∀” is the first English letter instead of the correct “A” since childhood, he/she subjectively presumes that “A” does not consist with the viewing direction when seeing “A”, and concludes that “A” is reversed “∀”. The special case discussed above is to emphasize the practical meaning of the viewing direction and certainly not the major concern of the present invention.

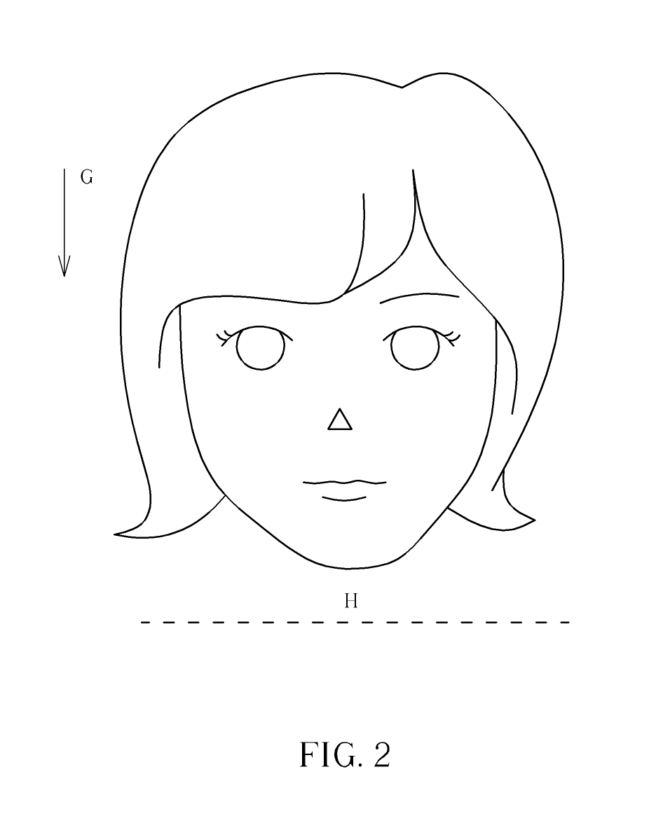

Since the viewing direction is hard to be characterized by a simple model, the viewing direction herein is described in another manner. In ordinary cases, people face the target object when watching the target object due to gravity, balance of eyes, etc. As to appearances, a face of a viewer can be characterized by FIG. 2 when the viewer is observed from the target object side. In FIG. 2, an arrow G represents a direction of gravity, and a dotted line H represents a horizontal line. As a result, even though the viewing direction can't be characterized by a specific model, the viewing direction still can be described based upon a fixed standard. For example, when the viewer normally observes the target object, a straight line starting from one eye of the viewer to another eye of the viewer is roughly parallel to the horizontal line H, and a straight line starting from a middle of the eyes of the viewer to a middle of a chin or a mouth of the viewer is roughly parallel to a vertical line, and the eyes are below eyebrows of the viewer, and a nose of the viewer is below the eyes, etc. The present invention utilizes these check references to determine a face direction of the viewer, so as to determine the viewing direction.

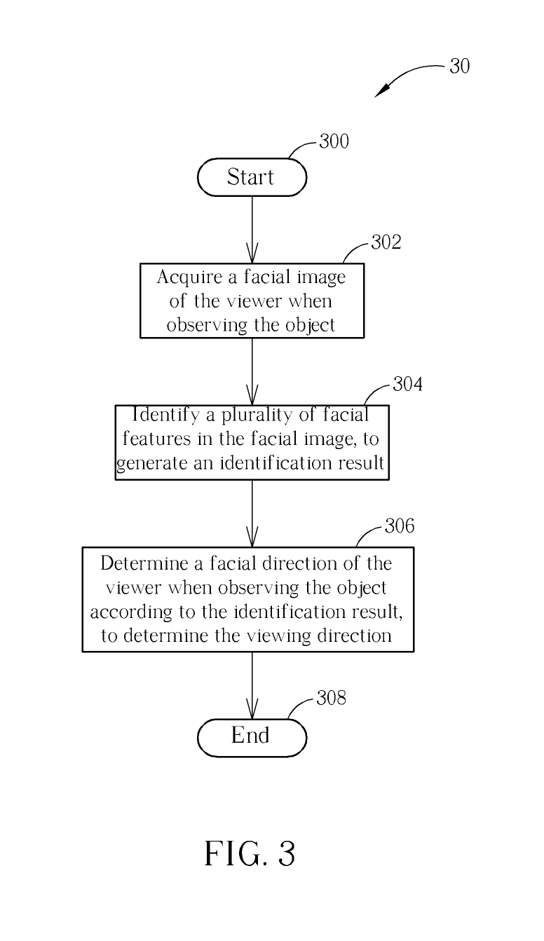

Please refer to FIG. 3, which is a schematic diagram of a viewing direction determination process 30 according to an embodiment of the present invention. The viewing direction determination process 30 is utilized for determining a viewing direction of a viewer when observing an object, and includes the following steps:

Step 300: Start.

Step 302: Acquire a facial image of the viewer when observing the object.

Step 304: Identify a plurality of facial features in the facial image, to generate an identification result.

Step 306: Determine a facial direction of the viewer when observing the object according to the identification result, to determine the viewing direction.

Step 308: End.

According to the viewing direction determination process 30, the present invention identities the facial features of the viewer by image recognition techniques, and accordingly determines the facial direction, so as to determine the viewing direction. Note that, the facial features can be body features of the viewer, such as eyes, nose, mouth, ear, eyebrows, etc., accessories like eyeglasses, earrings, etc., or other else. For example, the present invention first determines positions of the eyes and nose of the viewer, and then determines the facial direction of the user based upon a straight line starting from one eye of the user to another eye of the user or the position of the nose against the eyes, so as to determine whether or not the viewer normally observes the object, i.e. the viewing direction.

Therefore, the present invention can determine the facial direction of the viewer by identifying the facial features of the viewer, so as to determine the viewing direction. Such a determination process merely depends on the positions of the facial features of the viewer when observing the object, and is independent of gravity. Note that, the viewing direction determination process 30 is utilized for illustrating the spirit of the present invention, and can be modified and varied accordingly. For example, to acquire the facial image of the viewer, an image including the facial image, such as upper-half body image or full body image, can be first acquired, and then a facial contour can be identified by the facial recognition techniques, to acquire the facial image of the viewer. Note that, the face recognition techniques are widely employed nowadays, and identify the facial features based upon facts that human faces are oval, and most facial features within the facial contour exhibit the same color except for particular features like eyes, eyebrows, etc. Therefore, once the image including the facial image of the viewer is acquired, the facial contour can be determined based upon characteristic values of all pixels in the image, such as gray level, contrast, chrominance, luminance, etc.

Similarly, the facial features can be identified according to the same manner. That is, contours of the facial features can be identified based upon the characteristic values (like gray level, contrast, chrominance, luminance, etc.) of the pixels of the facial image of the viewer, to identify the facial features. Next, when the facial features of the viewer are identified, positions of the facial features against the facial image can be determined. Finally, the facial direction of the viewer can be determined based upon the positions of the facial features, to determine the viewing direction. For example, a straight starting from the middle of the eyes to the middle of the chin or the mouth is a vertical facial direction of the viewer, and a straight starting from a left eye of the viewer to a right eye of the viewer is a horizontal facial direction of the viewer (the left and right eyes can be determined based upon the position of the nose against the eyes).

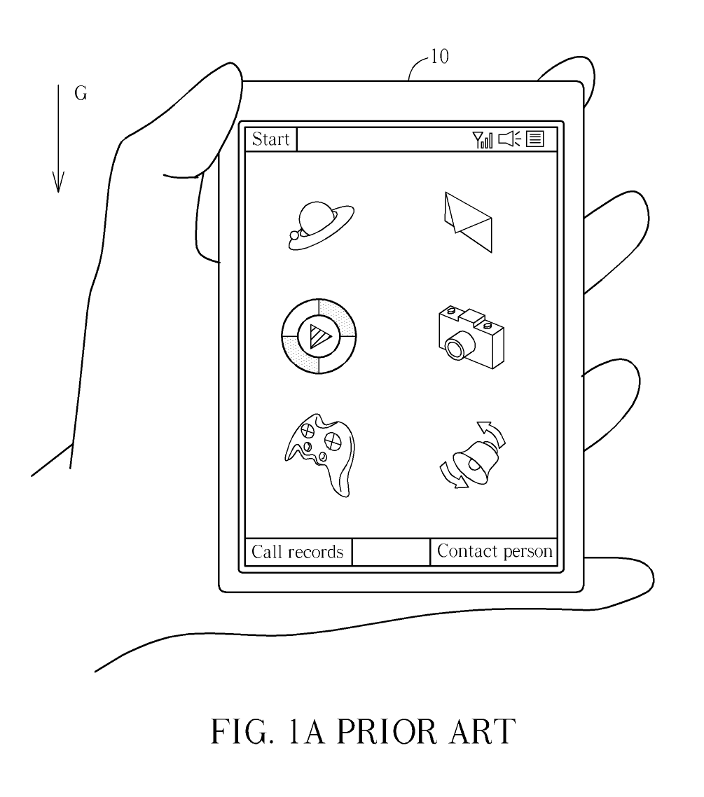

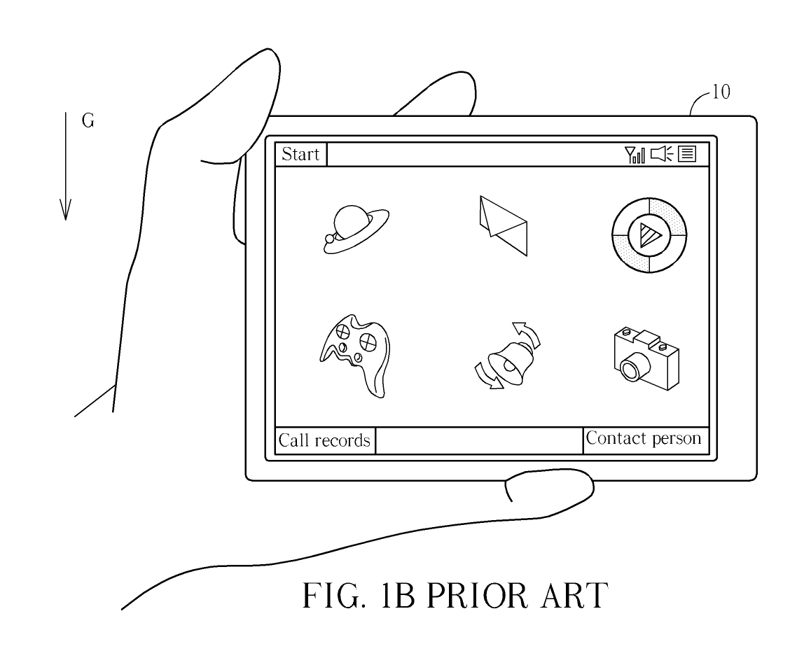

The present invention determines the facial direction based upon the facial features of the viewer, so as to determine the viewing direction. Such a determination process only depends on the facial angle of the viewer when observing the object, and is free of gravity basis. Therefore, if the viewing direction determination process 30 is applied to the smart phone 10 shown in FIG. 1A and FIG. 1B or the likes, the display direction switching scheme can normally function, to enhance utilization convenience and fun. Related implementation methods are described below.

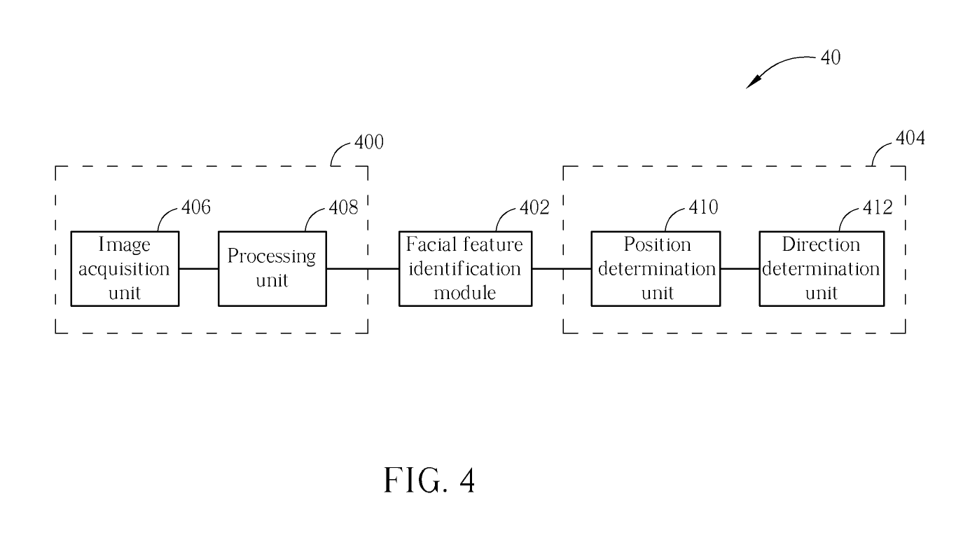

Please refer to FIG. 4, which is a schematic diagram of a viewing direction determination apparatus 40 according to an embodiment of the present invention. The viewing direction determination apparatus 40 is utilized for implementing the viewing direction determination process 30, to determine a viewing direction of a viewer when observing an object. The viewing direction determination apparatus 40 includes a facial image acquisition module 400, a facial feature identification module 402 and a determination module 404. The facial image acquisition module 400 is utilized for acquiring the facial image of the viewer when observing the object, and includes an image acquisition unit 406 and a processing unit 408. The image acquisition unit 406 can be a camera, and is utilized for acquiring an image comprising the facial image of the viewer when observing the object. The processing unit 408 can identify a facial contour of the viewer according to characteristic values (like gray level, contrast, chrominance, luminance, etc.) of pixels of the image acquired by the image acquisition unit 406, to acquire the facial image. The facial feature identification module 402 is utilized for identifying a plurality of facial features in the facial image, to generate an identification result. That is, the facial feature identification module 402 can imitate operations of the processing unit 408, i.e. identify contours of the facial features according to the characteristic values of the pixels of the facial image, to identify the facial features. The determination module 404 is utilized for determining the facial direction of the viewer (such as the vertical direction starting from the middle of the eyes to the middle of the chin or the horizontal direction starting from one eye to another eye) according to the identification result generated by the facial feature identification module 402, to determine the viewing direction. The determination module 404 includes a position determination unit 410 and a direction determination unit 412. The position determination unit 410 is utilized for determining positions of the facial features against the facial image according to the identification result. The direction determination unit 412 is utilized for determining the facial direction of the viewer according to results generated by the position determination unit 410, to determine the viewing direction.

The viewing direction determination apparatus 40 is utilized for implementing the viewing direction determination process 30, and related operations can be referred in the above. Note that, the facial image acquisition module 400, the facial feature identification module 402 and the determination module 404 are possible embodiments of the present invention, and not limited by these. For example, in addition to the camera, the image acquisition unit 406 can be a real-time image acquisition device, such as a video camera, infrared sensing equipment, etc. or a device (or module) without image acquisition function, such as a network download module, data readout module, etc. For example, if the image acquisition unit 406 is implemented by the data readout module, the data readout module acquires the image of the viewer by reading a storage device, such as a memory card, hard disk, etc.

The viewing direction determination process 30 and the viewing direction determination apparatus 40 determine the facial direction of the viewer based upon the facial features of the viewer, so as to determine the viewing direction. Generated based upon the facial features of the viewer, the determination result is independent of gravity, and thus the viewing direction determination process 30 and the viewing direction determination apparatus 40 can enhance utilization convenience and fun if applied to the display direction switching scheme of the portable device.

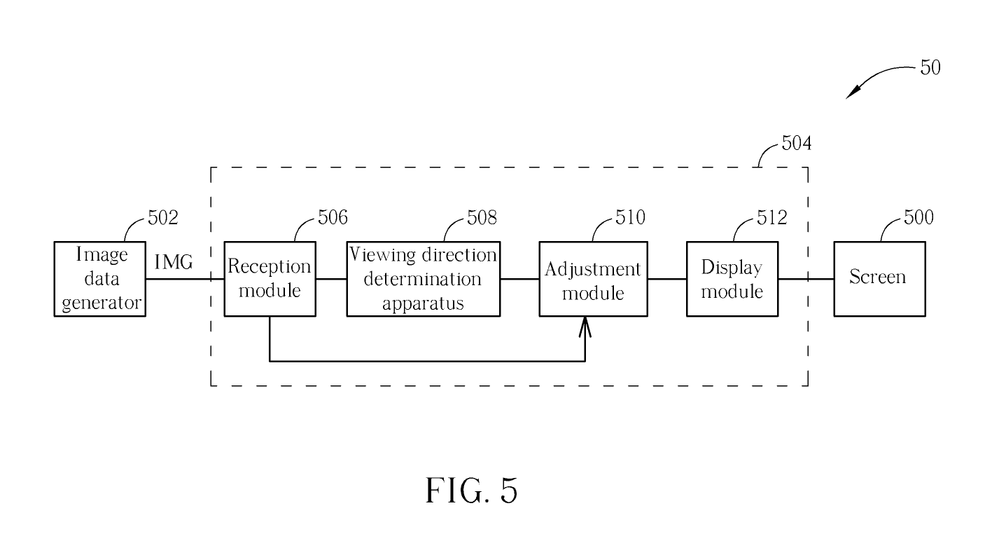

Please refer FIG. 5, which is a schematic diagram of a display device 50 according to an embodiment of the present invention. The display device 50 is preferably employed in a portable electronic device for switching a display direction according to a viewing direction of a user. The display device 50 includes a screen 500, an image data generator 502 and an image processing apparatus 504. The screen 500 can be a plane, three-dimensional, or projective screen or the likes with various appearances, such as a circle, rectangular, aspect ratio of 16:9, 16:10, etc., and includes a plurality of display units, each for displaying a pixel data. The image data generator 502 is utilized for generating image data IMG, which can be image files like JPEG, GIFF files, and includes a plurality of pixel data, each corresponding to a display unit of the screen 500. The image processing apparatus 504 includes a reception module 506, a viewing direction determination apparatus 508, an adjustment module 510 and a display module 512. The reception module 506 is utilized for receiving the image data IMG. The viewing direction determination apparatus 508 is preferably installed around the screen 500, and is utilized for determining the viewing direction of the user against the screen 500 when watching the screen 500. Related implementation methods can be referred from the viewing direction determination apparatus 40 shown in FIG. 4, and are not further narrated herein. The adjustment module 510 can adjust the display units corresponding to the pixel data in the image data IMG according to the viewing direction determined by the viewing direction determination apparatus 508. The display module 512 can drive the display units of the screen 500 to display the pixel data adjusted by the adjustment module 510, to display a frame corresponding to the image data IMG.

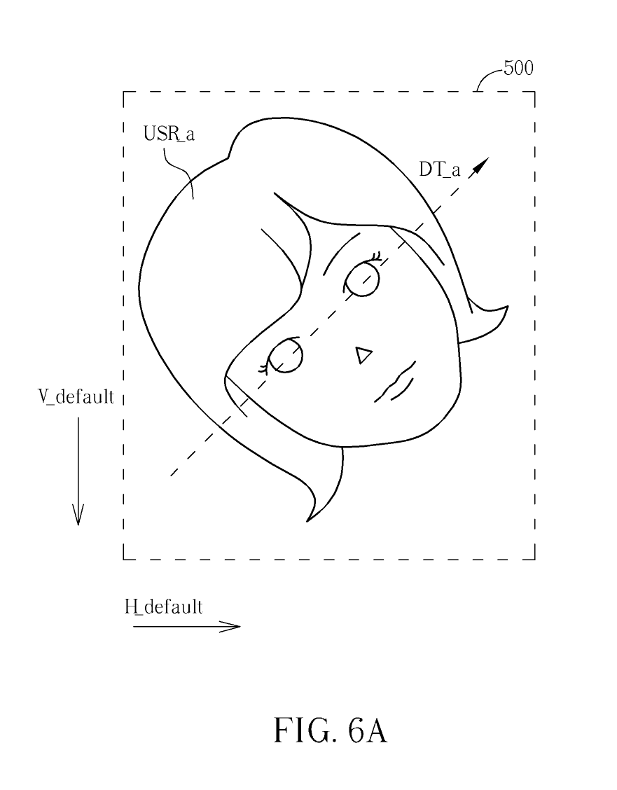

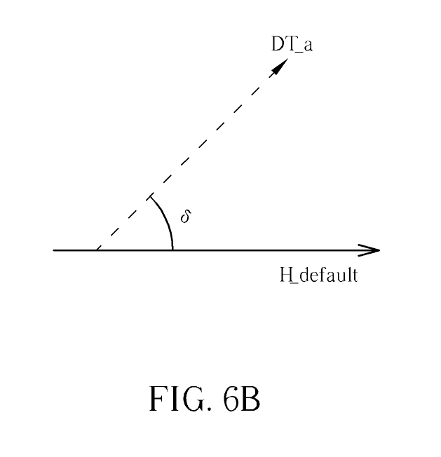

In short, the display device 50 can determine the facial direction and the viewing direction based upon the facial features of the user, and accordingly adjusts (converts) the display units corresponding to the display data, to correlate a frame display direction of the screen 500 with the viewing direction of the user. For example, when facing a user USR_a from a side of the screen 500, an image as illustrated in FIG. 6A can be observed, and directions V_default and H_default respectively represent a vertical (from top to bottom) direction and a horizontal direction of the screen 500. As illustrated in FIG. 6B, an angle between a direction DT_a starting from one eye to another eye of the user USR_a and the direction H_default is represented by δ. In such a situation, once the eyes, nose or mouth of the user USR_a are identified by the viewing direction determination apparatus 508, a facial horizontal direction of the user USR_a can be accordingly determined to be the direction DT_a. Next, the adjustment module 510 can adjust the display units corresponding to the pixel data in the image data IMG based upon the angle δ between the direction DT_a and the direction H_default, to ensure that frames displayed by the screen 500 fit the viewing direction of the user USR_a, i.e. the compensation angle δ.

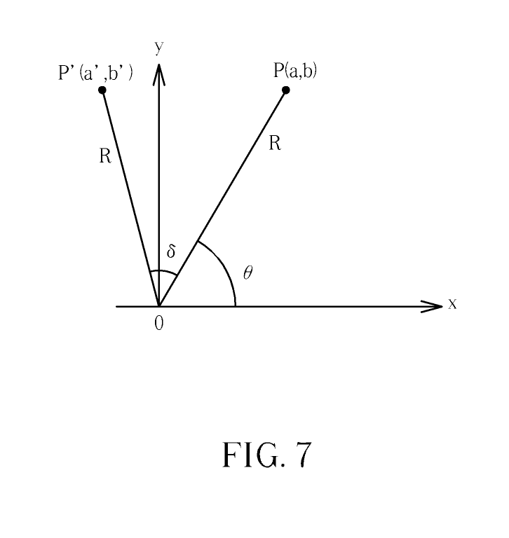

Note that, the directions V_default and H_default are vertical and horizontal frame directions before the adjustment module 510 performs adjustments, and are independent of content of the image data IMG. In addition, the adjustment module 510 can perform adjustments in any rules as long as the frames displayed by the screen 500 conform to the viewing direction of the user USR_a. For example, the pixel data of the image data IMG can be corresponded to a coordinate system, and coordinates thereof can be transformed by coordinate transformation after the angle δ between the directions DT_a and H_default is determined, to compensate the angle δ. Related operations are illustrated in FIG. 7. In this case, if a coordinate of a pixel datum P of the image data IMG is (a,b) with a distance R against an origin 0 and an angle θ from an x axis, the pixel datum P can be represented by P (R, θ) based upon a polar coordinate system, wherein R=\sqrt{a²+b²} and

$$θ = {tan}^{- 1} \frac{a}{b} .$$

According to coordinate transformation, a coordinate (a′,b′) and a polar coordinate P′(R, θ+δ) of a pixel datum P′ can be acquired by rotating the pixel datum P by the angle δ, wherein a′=R*cos(θ+δ) and b′=R*sin(θ+δ). Note that, the origin 0 may locate at any position in the frame, which depends on definitions of coordinate axes. For example, if the frame displayed by the screen 500 is a rectangular, and x, y axes thereof are corresponding to central lines of long and short sides of the rectangular, respectively, the origin 0 is a center of the rectangular. However, definitions of the axes and the origin only affect the processing of coordinate transformation, and are not the major concern of the present invention.

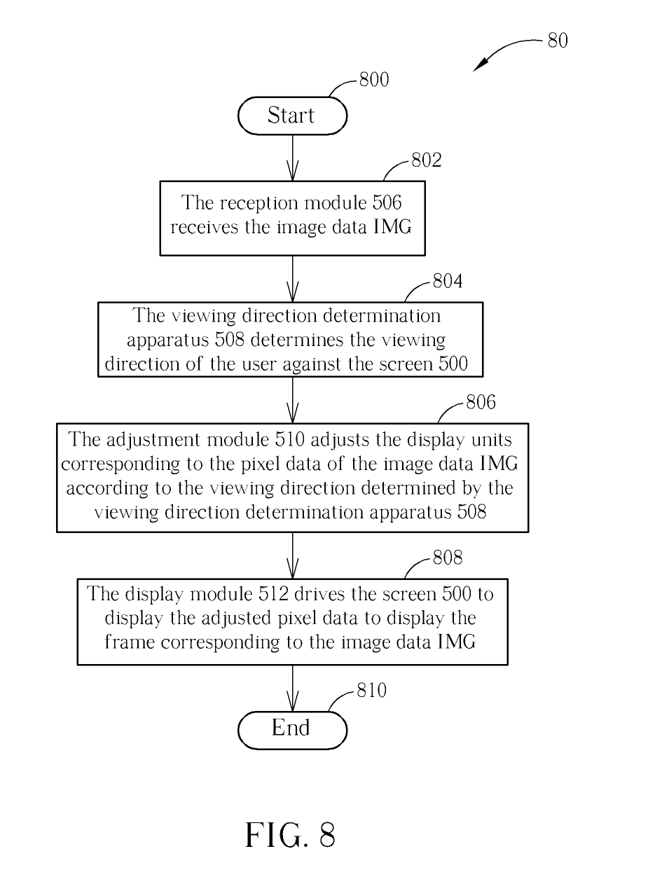

The aforementioned coordination transformation method is merely one possible adjustment method of the adjustment module 510, and can be replaced by other methods as long as the angle δ can be accordingly compensated. In the display device 50, the image processing apparatus 504 determines the facial direction based upon the facial features of the user, so as to determine the viewing direction. Related operations can be summarized into an image processing process 80, as illustrated in FIG. 8. The image processing process 80 includes the following steps:

Step 800: Start.

Step 802: The reception module 506 receives the image data IMG.

Step 804: The viewing direction determination apparatus 508 determines the viewing direction of the user against the screen 500.

Step 806: The adjustment module 510 adjusts the display units corresponding to the pixel data of the image data IMG according to the viewing direction determined by the viewing direction determination apparatus 508.

Step 808: The display module 512 drives the screen 500 to display the adjusted pixel data to display the frame corresponding to the image data IMG.

Step 810: End.

The image processing process 80 is utilized for describing the operations of the image processing apparatus 504, and details thereof can be referred from the above, and are not further narrated herein.

The viewing direction is not particularly specified in the above because the viewing direction depends on many factors, and the present invention aims at the viewing direction most people follow, i.e. observing the object horizontally with two eyes. Note that, the display device 50 shown in FIG. 5 is the embodiment of the present invention, and can be accordingly modified and varied. For example, in order to prevent the adjustment module 510 from frequent or erroneous adjustments, circuit designers can further increase time or angle thresholds for activation. For example, when the viewing direction determination apparatus 508 indicates that an angle difference between the facial direction and the display direction is greater than a default angle (for a period of time), the adjustment module 510 starts to adjust. Moreover, during the adjustment process, adjustment methods of the adjustment module 510 can be limited, to minimize resources required by the operations. For example, in FIG. 6A, when the angle δ is between 45 and 135 degrees, the frame is rotated by 90 degrees, i.e. the desired compensation angle is 90 degrees; when the angle δ is between 135 and 225 degrees, the frame is rotated by 180 degrees; when the angle δ is between 225 and 315 degrees, the frame is rotated by 270 degrees; and when the angle δ is between 315 and 45 degrees, the frame is not rotated.

In addition, when acquiring the image, more than one faces may be identified. In this case, the viewing direction determination apparatus 508 can select one of the faces, such as the closest or the middle one. On the contrary, if no face is identified, the adjustment module 510 can employ a default display direction.

On the other hand, since the screen 500 is rectangular in most cases, partial frame is probably cut off if the image data IMG are directly transformed between coordinate systems. In such a situation, the adjustment module 510 can further include a zoom function, to scale the image data IMG according to available display size of the screen 500. Moreover, the display device 50 can display a control menu on the screen 500 if the screen 500 is a touch screen, such that the adjustment module 510 can adjust a position and angle of the control menu as well as positions of related touch command icons on the screen 500. In addition, based upon the same concept, the facial features herein can be explained more broadly as body features, such as a relative position of a head against a body.

Note that, the display device 50 shown in FIG. 5 is an embodiment of the present invention, and can be modified and varied by those skilled in the art based upon practical system requirements. For example, when the display device 50 is implemented in a smart phone, a camera embedded in the smart phone or an extra camera can be utilized for acquiring the facial image of the user, so as to determine the facial direction and accordingly adjust the display direction of the screen. Related embodiments are illustrated below.

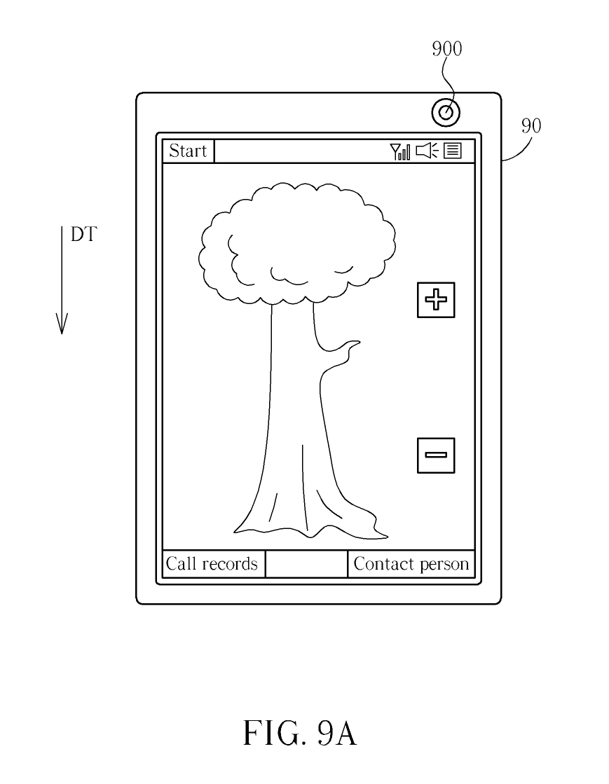

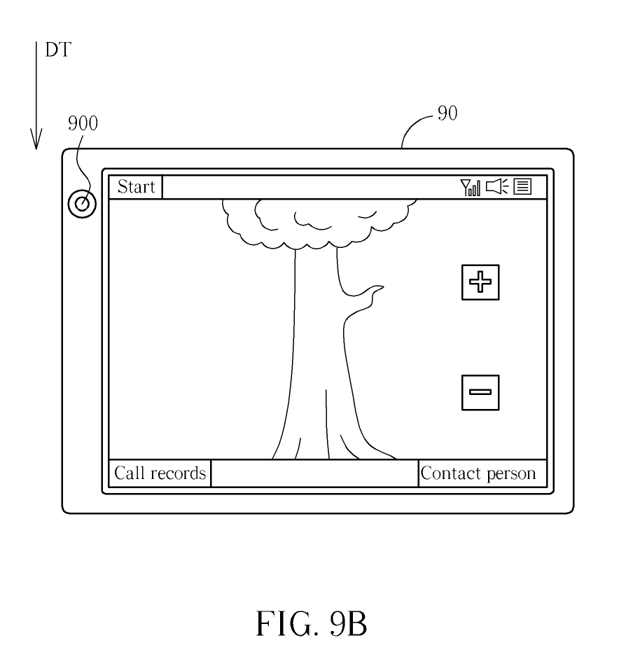

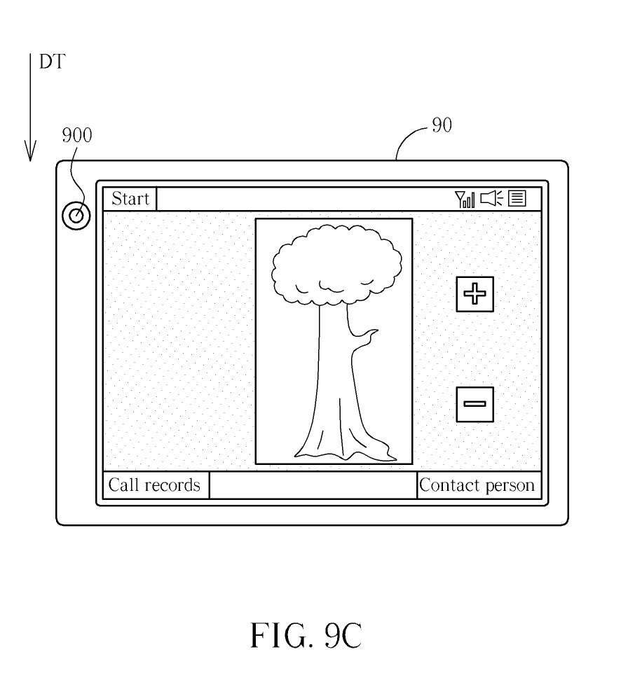

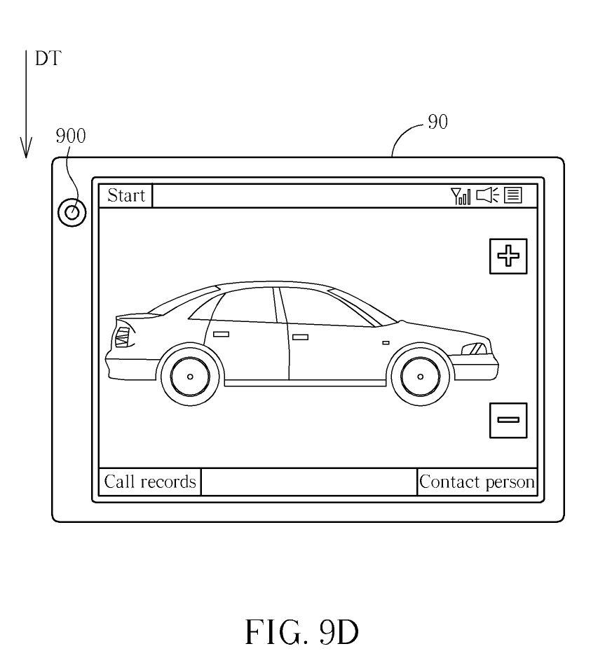

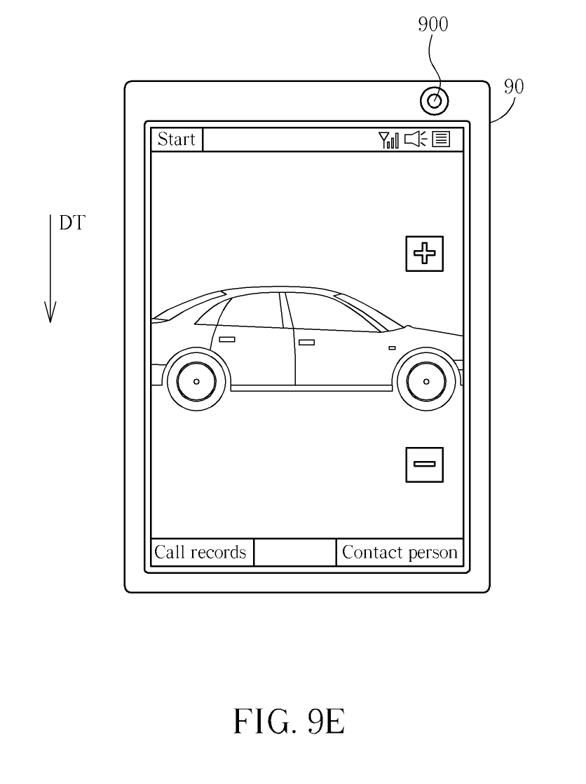

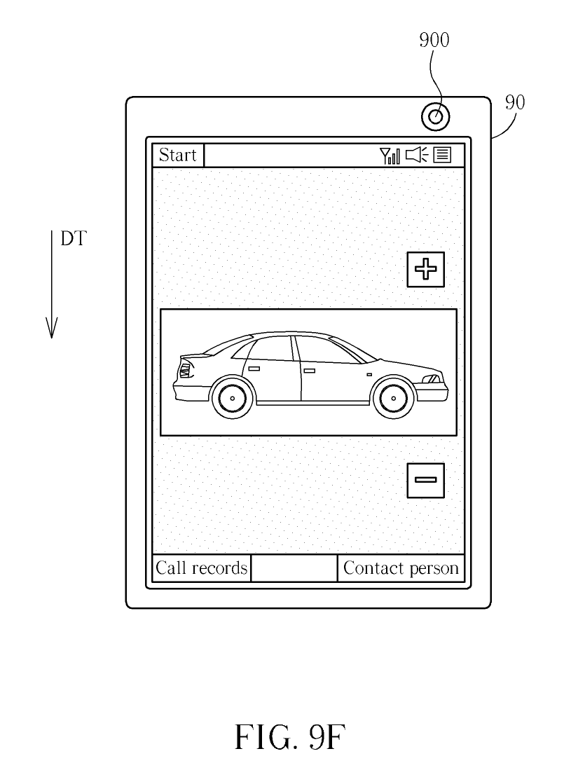

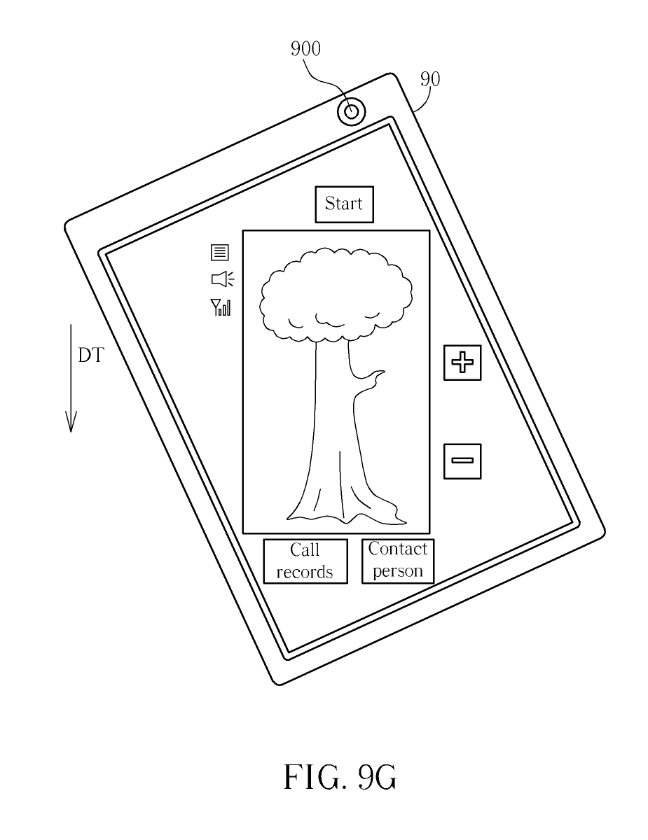

Please refer from FIG. 9A to FIG. 9G, which are schematic diagrams of a smart portable device 90 when operating according to embodiments of the present invention. A camera 900 is embedded within the smart portable device 90, and the display device 50 shown in FIG. 5 is employed as a display interface of the smart portable device 90. From FIG. 9A to FIG. 9G, a direction DT represents a direction starting from the middle of the eyes to the middle of the chin of the user, i.e. the vertical facial direction, and “+”, “−” respectively represent control icons for zooming in and zooming out a picture. If the user starts to watch a picture via the smart portable device 90 according to a method shown in FIG. 9A, frames displayed by the smart portable device 90 can be adjusted according to embodiments shown in FIG. 9B and FIG. 9C when the user rotates or moves the smart portable device 90 and causes a variance in the facial direction. In FIG. 9B, since the original frame is not zoomed, partial area of the frame is cut off. On the contrary, with adequate zooming operations, the frame can be completely displayed, as illustrated in FIG. 9C. Similarly, if the user watches another picture via the smart portable device 90 according to a method shown in FIG. 9D, the frames displayed by the smart portable device 90 can be adjusted according to display methods shown in FIG. 9E (without zooming) and FIG. 9F (with zooming) when the user rotates or moves the smart portable device 90. In respect of FIG. 9A, if the user rotates the smart portable device 90 by 45 degrees, the display direction of the frame can be accordingly rotated with a scaled frame size, as illustrated in FIG. 9G, or keep unchanged to reduce computation loading, or be alternated to the display method shown in FIG. 9B or FIG. 9C.

In addition, as illustrated from FIG. 9A to FIG. 9G, positions and text directions of the control icons “+”, “−” and task menus (like “Start”, “Call records” and “Contact person”) are adjusted with the display direction. Certainly, if necessary, positions of touch icons are according adjusted as well. For example, in FIG. 9A, the smart portable device 90 generates a command to show call records when the user clicks the task menu “Call records”. When the frame is adjusted as FIG. 9B shows, the task menu “Call records” is changed to be a horizontal task menu “Contact person”. In such a situation, if the user clicks the task menu “Contact person”, the smart portable device 90 generates a command to list the contact persons instead of the call records.

Zooming operations are required herein since the screen of the smart portable device 90 is rectangular. If circulars screen are employed as output interfaces in other applications, only coordinate transformations are required, and the zooming operations can be omitted. In addition, whether the viewer “directly” observes the object is not determined when determining the viewing direction. That is, even if the viewer squints when using the smart portable device 90, the viewing direction still can be determined according to the present invention. For example, in the case of FIG. 9A, if the user squints the smart portable device 90, or the camera 900 is horizontally rotatable while the user does not rotate the camera 900 to an original angle, the present invention still can correctly determine the viewing direction of the user and adequately adjust the display method of the smart portable device 90. Certainly, a function for calibrating squint cases may be included in specific embodiments, and is consistent with the operations of the present invention.

The prior art determines the viewing direction of the user based upon gravity variances. Thus, the viewing direction cannot be computed when the gravity variances are unavailable. In comparison, the present invention determines the facial direction based upon the facial features of the viewer, so as to determine the viewing direction. Since the determination result is generated based upon the facial features of the viewer, the determination result is independent of gravity, and thus reliability and correctness can be enhanced. If the present invention is applied to the display direction switching scheme of the smart portable devices, utilization convenience and fun can be enhanced as well.

To sum up, the present invention determines the facial direction based upon the facial features of the viewer, so as to determine the viewing direction. Since the determination process merely depends on the positions of the facial features when the viewer observing the object and is independent of gravity, precision of the determination result and performances of related applications (such as the display direction switching scheme) can be enhanced.

Those skilled in the art will readily observe that numerous modifications and alterations of the device and method may be made while retaining the teachings of the invention.

What is claimed is:

1. A viewing direction determination method, for determining a viewing direction of a viewer when observing an object, the viewing direction determination method comprising:
acquiring a facial image of the viewer when observing the object;
identifying a plurality of facial features in the facial image, to generate an identification result; and
determining a facial direction of the viewer when observing the object according to the identification result, to determine the viewing direction.

2. The viewing direction determination method of claim 1, wherein the step of acquiring the facial image of the viewer when observing the object comprises:
acquiring an image comprising the facial image of the viewer when observing the object; and
identifying a facial contour of the viewer in the image according to characteristic values of a plurality of pixels included in the image, to acquire the facial image of the viewer when observing the object.

3. The viewing direction determination method of claim 1, wherein the step of identifying the plurality of facial features in the facial image comprises identifying contours of the plurality of facial features in the facial image according to characteristic values of a plurality of pixels included in the facial image, to identify the plurality of facial features.

4. The viewing direction determination method of claim 1, wherein the step of determining the facial direction of the viewer when observing the object according to the identification result, to determine the viewing direction, comprises:
determining a plurality of positions of the plurality of facial features against the facial image according to the identification result; and
determining the facial direction of the viewer when observing the object according to the plurality of positions, to determine the viewing direction.

5. The viewing direction determination method of claim 1, wherein the facial direction is a vertical direction starting from a middle of eyes of the viewer to a middle of a chin of the viewer.

6. The viewing direction determination method of claim 1, wherein the facial direction is a horizontal direction starting from one eye of the viewer to another eye of the viewer.

7. A viewing direction determination apparatus, for determining a viewing direction of a viewer when observing an object, the viewing direction determination apparatus comprising:
a facial image acquisition module, for acquiring a facial image of the viewer when observing the object;
a facial feature identification module, for identifying a plurality of facial features in the facial image, to generate an identification result; and
a determination module, for determining a facial direction of the viewer when observing the object according to the identification result, to determine the viewing direction.

8. The viewing direction determination apparatus of claim 7, wherein the facial image acquisition module comprises:
an image acquisition unit, for acquiring an image comprising the facial image of the viewer when observing the object; and
a processing unit, for identifying a facial contour of the viewer in the image according to characteristic values of a plurality of pixels included in the image, to acquire the facial image.

9. The viewing direction determination apparatus of claim 7, wherein the facial feature identification module identifies contours of the plurality of facial features in the facial image according to characteristic values of a plurality of pixels included in the facial image, to identify the plurality of facial features.

10. The viewing direction determination apparatus of claim 7, wherein the determination module comprises:
a position determination unit, for determining a plurality of positions of the plurality of facial features against the facial image according to the identification result; and
a direction determination unit, for determining the facial direction of the viewer when observing the object according to the plurality of positions, to determine the viewing direction.

11. The viewing direction determination apparatus of claim 7, wherein the facial direction is a vertical direction starting from a middle of eyes of the viewer to a middle of a chin of the viewer.

12. The viewing direction determination apparatus of claim 7, wherein the facial direction is a horizontal direction starting from one eye of the viewer to another eye of the viewer.

13. An image processing method for a display device comprising a screen, the image processing method comprising:
receiving an image data comprising a plurality of pixel data corresponding to a plurality of display units of the screen;
determining a viewing direction of a user when observing the screen;
adjusting the display units corresponding to the plurality of pixel data according to the viewing direction; and
the plurality of display units displaying the adjusted pixel data to display a frame corresponding to the image data.

14. The image processing method of claim 13, wherein the step of determining the viewing direction of the user when observing the screen comprises:
acquiring a facial image of the user when observing the object;
identifying a plurality of facial features in the facial image, to generate an identification result; and
determining a facial direction of the user when observing the screen according to the identification result, to determine the viewing direction.

15. The image processing method of claim 14, wherein the step of acquiring the facial image of the user when observing the object comprises:
acquiring an image comprising the facial image of the user when observing the screen; and
identifying a facial contour of the user in the image according to characteristic values of a plurality of pixels included in the image, to acquire the facial image of the user when observing the object.

16. The image processing method of claim 15, wherein the characteristic values of the plurality of pixels are selected from a group comprising gray level, contrast, chrominance and luminance.

17. The image processing method of claim 14, wherein the step of identifying the plurality of facial features in the facial image comprises identifying contours of the plurality of facial features in the facial image according to characteristic values of a plurality of pixels included in the facial image, to identify the plurality of facial features.

18. The image processing method of claim 17, wherein the characteristic values of the plurality of pixels are selected from a group comprising gray level, contrast, chrominance and luminance.

19. The image processing method of claim 14, wherein the step of determining the facial direction of the user when observing the screen according to the identification result, to determine the viewing direction, comprises:
determining a plurality of positions of the plurality of facial features against the facial image according to the identification result; and
determining the facial direction of the user when observing the screen according to the plurality of positions, to determine the viewing direction.

20. The image processing method of claim 14, wherein the facial direction is a vertical direction starting from a middle of eyes of the user to a middle of a chin of the user.

21. The image processing method of claim 14, wherein the facial direction is a horizontal direction starting from one eye of the user to another eye of the user.

22. The image processing method of claim 14, wherein the plurality of facial features are selected from a group comprising eyes, nose, mouth, ear, eyebrows, eyeglasses, earrings and chin.

23. The image processing method of claim 13, wherein the step of adjusting the display units corresponding to the plurality of pixel data according to the viewing direction comprises adjusting the display units corresponding to the plurality of pixel data according to the viewing direction, such that the plurality of display units display the frame in a direction related to the viewing direction.

24. The image processing method of claim 13 further comprising scaling the frame according to a display range of the screen.

25. The image processing method of claim 13 further comprising adjusting positions and angles of a plurality of menus of the display device on the screen according to the viewing direction.

26. An image processing apparatus for a display device comprising a screen, the image processing apparatus comprising:
a reception module, for receiving an image data comprising a plurality of pixel data corresponding to a plurality of display units of the screen;
a viewing direction determination apparatus, for determining a viewing direction of a user against the screen;
an adjustment module, for adjusting the display units corresponding to the plurality of pixel data according to the viewing direction; and
a display module, for driving the plurality of display units to display the adjusted pixel data to display a frame corresponding to the image data.

27. The image processing apparatus of claim 26, wherein the viewing direction determination apparatus comprises:
a facial image acquisition module, for acquiring a facial image of the user when observing the screen;
a facial feature identification module, for identifying a plurality of facial features in the facial image, to generate an identification result; and
a determination module, for determining a facial direction of the user when observing the screen according to the identification result, to determine the viewing direction.

28. The image processing apparatus of claim 27, wherein the facial image acquisition module comprises:
an image acquisition unit, for acquiring an image comprising the facial image of the user when observing the object; and
a processing unit, for identifying a facial contour of the user in the image according to characteristic values of a plurality of pixels included in the image, to acquire the facial image.

29. The image processing apparatus of claim 28, wherein the characteristic values of the plurality of pixels are selected from a group comprising gray level, contrast, chrominance and luminance.

30. The image processing apparatus of claim 27, wherein the facial feature identification module identifies contours of the plurality of facial features in the facial image according to characteristic values of a plurality of pixels included in the facial image, to identify the plurality of facial features.

31. The image processing apparatus of claim 30, wherein the characteristic values of the plurality of pixels are selected from a group comprising gray level, contrast, chrominance and luminance.

32. The image processing apparatus of claim 27, wherein the determination module comprises:
a position determination unit, for determining a plurality of positions of the plurality of facial features against the facial image according to the identification result; and
a direction determination unit, for determining the facial direction of the user when observing the screen according to the plurality of positions, to determine the viewing direction.

33. The image processing apparatus of claim 27, wherein the facial direction is a vertical direction starting from a middle of eyes of the user to a middle of a chin of the user.

34. The image processing apparatus of claim 27, wherein the facial direction is a horizontal direction starting from one eye of the user to another eye of the user.

35. The image processing apparatus of claim 27, wherein the plurality of facial features are selected from a group comprising eyes, nose, mouth, ear, eyebrows, eyeglasses, earrings and chin.

36. The image processing apparatus of claim 26, wherein the adjustment module is utilized for adjusting the display units corresponding to the plurality of pixel data according to the viewing direction, such that the plurality of display units displays the frame in a direction related to the viewing direction.

37. The image processing apparatus of claim 26, wherein the adjustment module is further utilized for scaling the frame according to a display range of the screen.

38. The image processing apparatus of claim 26, wherein the adjustment module is further utilized for adjusting positions and angles of a plurality of menus of the display device on the screen according to the viewing direction.

39. A display device capable of automatically alternating viewing directions comprising:
a screen, comprising a plurality of display units;
an image data generator, for generating an image date comprising a plurality of pixel data corresponding to the plurality of display units; and
an image processing apparatus, for processing the image data and displaying the processed image data through the screen, comprising:
a reception module, for receiving the image data;
a viewing direction determination apparatus, for determining a viewing direction of a user against the screen;
an adjustment module, for adjusting the display units corresponding to the plurality of pixel data according to the viewing direction; and
a display module, for driving the plurality of display units to display the adjusted pixel data to display a frame corresponding to the image data.

40. The display device of claim 39, wherein the viewing direction determination apparatus comprises:
a facial image acquisition module, for acquiring a facial image of the user when observing the screen;
a facial feature identification module, for identifying a plurality of facial features in the facial image, to generate an identification result; and
a determination module, for determining a facial direction of the user when observing the screen according to the identification result, to determine the viewing direction.

41. An electronic device capable of displaying comprising:
a screen, comprising a plurality of display units; and
an image processing apparatus, comprising:
a reception module, for receiving an image data comprising a plurality of pixel data corresponding to the plurality of display units of the screen;
a viewing direction determination apparatus, for determining a viewing direction of a user against the screen;
an adjustment module, for adjusting display units to be corresponding to the plurality of pixel data according to the viewing direction of the user against the screen; and
a display module, for driving the plurality of display units to display the adjusted pixel data, to display a frame corresponding to the image data.
